(19) United States
(12) Patent Application Publication
(10) Pub. No.: US 2010/0231951 A1
(43) Pub. Date: Sep. 16, 2010

(54) PRINTING APPARATUS TERMINAL AND METHOD FOR CONTROLLING THE SAME

(75) Inventors: Yasuhiro Oshima, Matsumoto-shi (JP); Kenji Sakuda, Suwa-shi (JP); Takafumi Higuchi, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/722,451

(22) Filed: Mar. 11, 2010

(30) Foreign Application Priority Data
Mar. 13, 2009 (JP) 2009-061876

(51) Int. Cl. G06K 15/02

(52) U.S. Cl. 358/1.14

(57) ABSTRACT

A printing apparatus terminal connected to a communication network has a printer, which prints printing contents on a printing medium.

### BACKGROUND

1. Technical Field

The entire disclosure of Japanese Patent Application No. 2009-061876, filed Mar. 13, 2009 is expressly incorporated by reference herein.

The present invention relates to a printing apparatus terminal and a method for controlling the same, and more particularly, to a printing apparatus terminal connected to a communication network and having a printer, which prints printing contents on a printing medium, in which the printing apparatus terminal establishes a communication connection with a transmitting terminal through the communication network by transmitting a connection approval signal to the transmitting terminal through the communication network in response to a connection request signal, which is received through the communication network from the transmitting terminal, which is connected to the communication network to transmit the printing contents through the communication network, and a method for controlling the same printing apparatus terminal when transmitting the connection approval signal.

2. Related Art

In the related art, as such a printing apparatus terminal, a facsimile (FAX) or a printer-connected personal computer (PC), which prints printing data, received through a communication network such as a telephone line or the Internet, is known. The FAX, which receives the printing data through the telephone line, responds to a call using a FAX signal, and prints the printing data whenever receiving the data or after storing the data in memory. The PC, which receives the printing data through the Internet, stores the printing data on an external storage device such as a hard disc drive, and then reads and prints the printing data stored on the external storage device by running a printing application program. In addition, technologies relating to the transmission of information through the network are known, which are described in the patent documents, such as JP-A-2005-109701, JP-A-2003-178028, and JP-T-2005-516320.

Recently, a Next Generation Network (NGN), which has the flexibility and economic power of an Internet Protocol (IP) network while ensuring reliability and stability, has been proposed as a next-generation information communication network. This NGN uses the Session Initiation Protocol (SIP) as a protocol that generates, changes, and segments a session necessary for exchanging voice, image, or text messages with respect to two or more counterparts in application layers. In the establishment of the session between devices using the SIP, an offering terminal requests the establishment of a session from an answering terminal by transmitting an INVITE message to the answering terminal, in which the INVITE message includes a Uniform Resource Identifier (URI) indicating the location of the answering terminal on a network, and the answering terminal transmits “200 OK,” which is a state code approving the establishment of the session, to the offering terminal. In this manner, the session established. When the answering terminal is a printing apparatus terminal, which prints the printing contents, a predetermined preparation procedure is often necessary for the initiation of the printing. In addition, for the purposes of power saving, when printing is not performed for a predetermined time such a printing apparatus terminal is often shifted from a standby mode, in which the printing is ready, to a sleeping mode, in which printing preparation is required. If the session is established based on the SIP by setting the printing apparatus terminal as the answering terminal, printing preparation is required after the establishment of the session. Accordingly, it is impossible to transmit or receive the printing contents until the printing preparation is completed. In addition, in the case where the establishment of the session by the network is charged, not only the time period used for printing the printing contents but also the time period used for printing preparation are charged.

### SUMMARY

An advantage of some aspects of the invention is that a printing apparatus terminal and a method for controlling the same establish a communication connection in the state where printing preparation is completed.

The printing apparatus terminal and a method for controlling the same of the present invention provide the following exemplary embodiments.

The printing apparatus terminal according to an exemplary embodiment of the invention is connected to a communication network and has a printer, which prints printing contents on a printing medium. The printing apparatus terminal establishes a communication connection with a transmitting terminal through the communication network by transmitting a connection approval signal to the transmitting terminal through the communication network in response to a connection request signal, which is received through the communication network from the transmitting terminal, which is connected to the communication network to transmit the printing contents through the communication network. The printing apparatus terminal includes a connection approval signal transmission processor, which, when the connection request signal is received, if printing preparation is completed so that the printer is ready to print, promptly transmits the connection approval signal to the transmitting terminal through the communication network, and if printing preparation is not completed, performs printing preparation and transmits the connection approval signal to the transmitting terminal through the communication network when printing preparation is completed.

In the printing apparatus terminal according to an exemplary embodiment of the invention, when the connection request signal is received, it is possible to promptly transmit the connection approval signal to the transmitting terminal if printing preparation is completed so that the printer is ready to print. If printing preparation is not completed, the printing apparatus terminal performs printing preparation and, after printing preparation is completed, transmits the connection approval signal through the communication network to the transmitting terminal. Accordingly, even if the connection request signal is received when printing preparation is not completed, it is possible to establish the communication connection after printing preparation is completed. As a result, even if the printing contents are transmitted from the transmitting terminal right after the transmission of a connection complete signal from the printing apparatus terminal, it is possible to receive and print the printing contents. In addition, in the case where the establishment of the communication connection is charged, it is possible to prevent the time period used for printing preparation from being charged. Herein, the communication network can be a Next Generation Network (NGN), or the establishment of the communication connection can be session establishment based on the Session Initiation Protocol (SIP).

In the printing apparatus terminal according to an exemplary embodiment of the invention, if printing preparation is not completed and when printing preparation is being performed, the connection approval signal transmission processor may transmit the connection approval signal even if printing preparation is not completed if a predetermined time is passed after the connection request signal is received. Herein, when a time period that is somewhat shorter than a certain time (i.e., a time-out time) when the transmitting terminal abandons the establishment of the communication connection when the connection approval signal is not received for the certain time after the transmission of the connection request signal from the transmitting terminal is used as the predetermined time, it is possible to prevent the failing of the establishment of the communication connection by time-out.

The method for controlling a printing apparatus terminal according to an exemplary embodiment of the invention controls the printing apparatus terminal when transmitting a connection approval signal. The printing apparatus terminal is connected to a communication network and has a printer, which prints printing contents on a printing medium. The printing apparatus terminal establishes a communication connection with a transmitting terminal through the communication network by transmitting the connection approval signal to the transmitting signal through the communication network in response to a connection request signal, which is received through the communication network from the transmitting terminal, which is connected to the communication network to transmit the printing contents through the communication network. When the connection request signal is received, if printing preparation is completed so that the printer is ready to print, the method promptly transmits the connection approval signal to the transmitting terminal through the communication network. If printing preparation is not completed, the method performs printing preparation and transmits the connection approval signal to the transmitting terminal through the communication network when printing preparation is completed.

In the method for controlling a printing apparatus terminal, when the connection request signal is received, it is possible to promptly transmit the connection approval signal to the transmitting terminal if printing preparation is completed so that the printer is ready to print. If printing preparation is not completed, printing preparation is performed and, after printing preparation is completed, the connection approval signal is transmitted to through the communication network to the transmitting terminal. Accordingly, even if the connection request signal is received when printing preparation is not completed, it is possible to establish the communication connection after printing preparation is completed. As a result, even if the printing contents are transmitted from the transmitting terminal right after the transmission of a connection complete signal from the printing apparatus terminal, it is possible to receive and print the printing contents. In addition, in the case where the establishment of the communication connection is charged, it is possible to prevent a time period used for printing preparation from being charged. Herein, the communication network can be a Next Generation Network (NGN), or the establishment of the communication connection can be session establishment based on the Session Initiation Protocol (SIP).

### BRIEF DESCRIPTION OF THE DRAWINGS

The invention will be described with reference to the accompanying drawings, wherein like numbers reference like elements.

FIG. 1 is an explanatory view showing an IP network, a transmitting terminal, and a receiving terminal.

FIG. 2 is an explanatory view showing a communication sequence between the transmitting terminal and the receiving terminal.

FIG. 3 is a flowchart showing an example of a response process performed by a printing apparatus terminal 30.

FIG. 4 is a flowchart showing an example of a response process according to a modified embodiment.

### DESCRIPTION OF EXEMPLARY EMBODIMENTS

Hereinafter, exemplary embodiments of the present invention will be described.

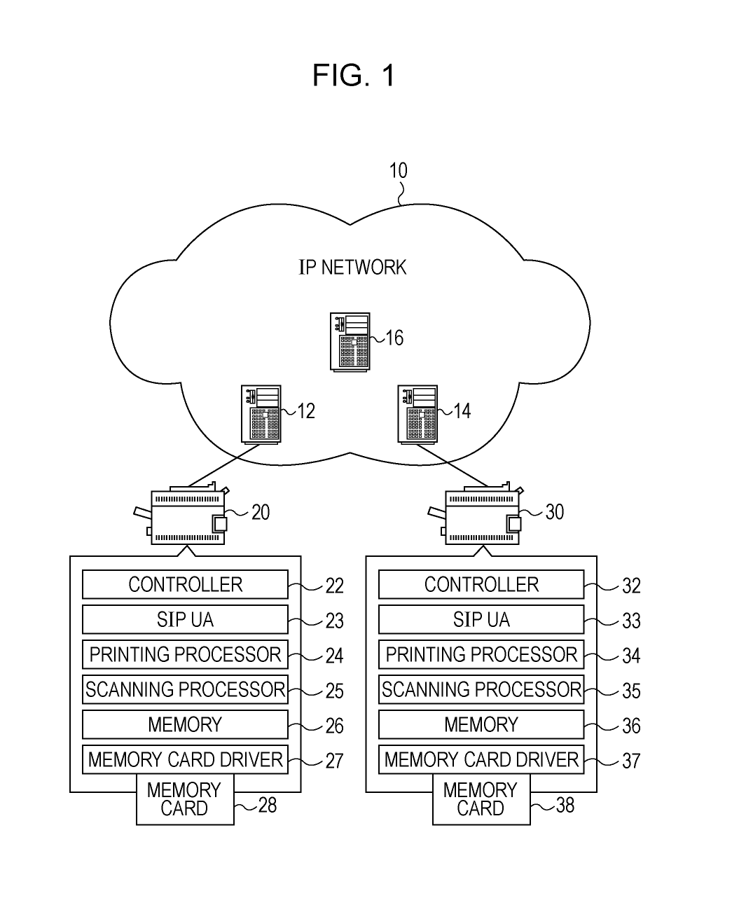

FIG. 1 is a configuration view showing an example of the configuration of image processing apparatuses 20 and 30, which act as printing apparatus terminals according to an exemplary embodiment of the invention, and an Internet Protocol (IP) network 10 to which the image processing apparatuses 20 and 30 are connected. As shown in the figure, the image processing apparatuses 20 and 30 are connected to respective Session Initiation Protocol (SIP) proxy servers 12 and 14, which construct the IP network 10.

IP network 10 is constructed, for example, as a Next Generation Network (NGN), and by the Session Initiation Protocol (SIP) proxy servers 12 and 14, a location server 16, and the like. The SIP proxy servers 12 and 14 not only relay IP messages but also function as registrars that registers location information (e.g., Uniform Resource Identifier (URI)) of the user agents of the image processing apparatuses 20 and 30 in the location server 16.

The image processing apparatuses 20 and 30 are constructed as multifunction machines that can function as both a scanner and a printer. The image processing apparatuses 20 and 30 include controllers 22 and 32, which control all of the apparatus, user agents (SIPUAs) 23 and 33, which are for the SIP, printing processors 24 and 34, which print texts, image data, or the like, scanning processors 25 and 35, which obtain image data by scanning texts, images, or the like on a medium such as a sheet of paper, memories 26 and 36, which temporarily store data to be printed or image data obtained by scanning, card drivers 27 and 37, which write data in memory cards 28 and 38 or read data stored in the memory cards 28 and 38 when the memory cards 28 are 38 are connected, and the like.

In the following description, the image processing apparatus 20 will be referred to as a “transmitting terminal 20” and the image processing apparatus 30 will be referred to as a “receiving terminal 30” in order to assume a case, in which printing contents data, such as image data scanned by the image processing apparatus 20 or image data stored in the memory card 28 connected to the image processing apparatus 20, are transmitted from the image processing apparatus 20 through the IP network 10 to the image processing apparatus 30, which, upon receiving the printing contents data by the image processing apparatus 30, prints the printing contents data or stores the printing contents data in the memory card 38.

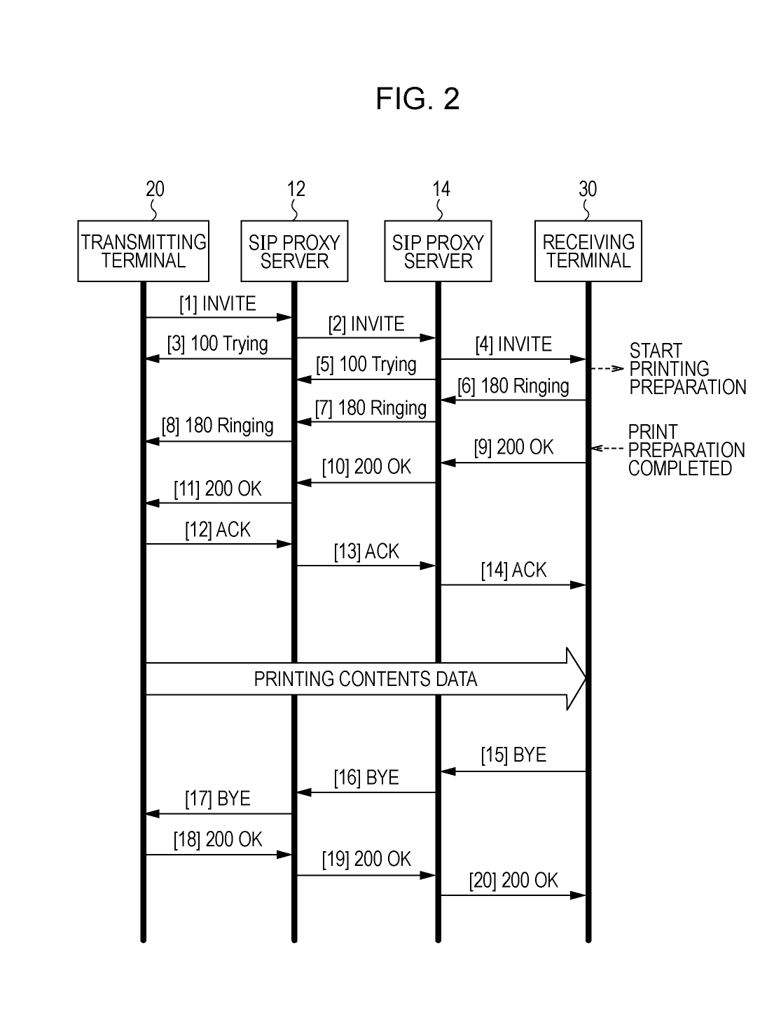

FIG. 2 is an explanatory view showing a communication sequence between the transmitting terminal 20 and the receiving terminal 30, in which the transmitting terminal 20 transmits printing contents data, such as image data scanned by the transmitting apparatus 20 or image data stored in the memory card 28 connected to the transmitting terminal 20, to the receiving terminal 30, and the receiving terminal 30, upon receiving the image data, prints the image data or stores the image data in the memory card 38. The session establishment based on the SIP is initiated by the transmitting terminal 20 transmitting an INVITE message to the receiving terminal 30. The INVITE message from the transmitting terminal 20 is primarily transmitted to the SIP proxy server 12. The SIP proxy server 12 transmits a reply “100Trying,” which is a state code indicating that the message is being processed, to the transmitting terminal 20 and, based on the Uniform Resource Identifier (URI) of the receiving terminal 30, which is described in the INVITE message, transmits the INVITE message to the SIP proxy server 14. The SIP proxy server 14 transmits a reply “100Trying,” which is a state code indicating that the message is being processed, to the SIP proxy server 12 and, based on the Uniform Resource Identifier (URI) of the receiving terminal 30, which is described in the INVITE message, transmits the INVITE message to the receiving terminal 30. The receiving terminal 30, upon receiving the INVITE message, transmits a reply “180 Ringing,” which is a state code indicating that it is being called. The reply “180 Ringing” is transmitted to the transmitting terminal 20 through the SIP proxy server 14 and the SIP proxy server 12. Afterwards, when the transmitting terminal 30 transmits “200 OK,” which is a state code indicating the success of a session establishment call, in response to the received INVITE message, the “200 OK” is transmitted to the transmitting terminal 20 through the SIP proxy server 14 and the SIP proxy server 12. Upon receiving the “200 OK,” the transmitting terminal 20 transmits “ACK,” which is a state code indicating an acknowledgment of the final reply to the INVITE message, to the receiving terminal 30 through the SIP proxy server 12 and the SIP proxy server 14. Through the above processing, the connection between the transmitting terminal 20 and the receiving terminal 30 is established, and the transmitting terminal 20 can transmit printing contents data to the receiving terminal 30. In addition, when the transmitting terminal 20 stops transmitting the printing contents data and the receiving terminal 30 stops printing the printing contents data or writing the printing contents data in the memory card 38, the receiving terminal 30 transmits “BYE,” which is a state code for closing the session, to the transmitting terminal 20 through the SIP proxy server 14 and the SIP proxy server 12. In response to “BYE,” the transmitting terminal 20 transmits “200 OK” to the receiving terminal 30 through the SIP proxy server 12 and the SIP proxy server 14, thereby closing the session. Since the session is established and closed through the SIP proxy server 12 and the SIP proxy server 14, an operator of the SIP proxy server 12 and the SIP proxy server 14 can calculate a price (i.e., charge a fee) for the service of the session establishment to the transmitting terminal 20 and the receiving terminal 30 by acquiring the date and time of the session establishment and the date and time of the session closing between the transmitting terminal 20 and the receiving terminal 30.

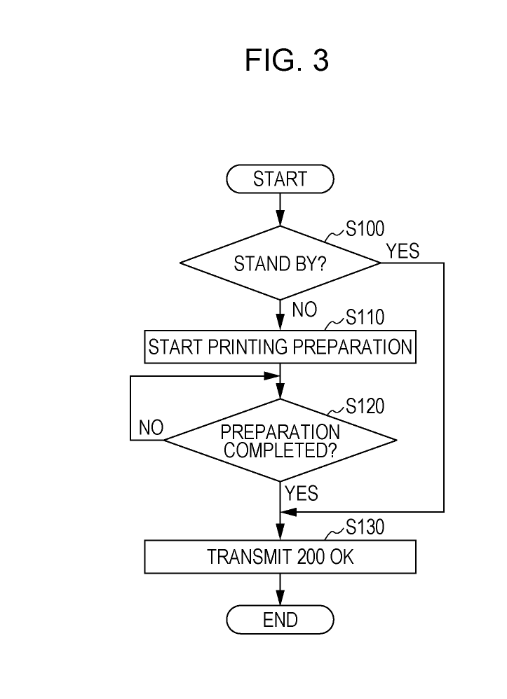

In this exemplary embodiment, when the INVITE message is received through the SIP proxy server 12 and the SIP proxy server 14 from the transmitting terminal 20, the receiving terminal 30 promptly transmits the reply “180 Ringing,” which is a state code indicating that it is being called. However, in the case of the “200 OK,” which is a state code indicating the success of a call, the receiving terminal 30 does not promptly transmit a reply but executes, by the controller 32, a response process as illustrated in FIG. 3. In the response process, the controller 32 examines, first of all, whether or not the printing processor 34 is in a standby state, in which it is ready to print (step S100), and if the printing processor 34 is standing by, promptly transmits “200 OK” (step S130), thereby stopping the response process. As an example in which the printing processor 34 is not standing by, the printing processor 34 is in power-saving mode in which an electric current is not applied to a component of the printing processor 34, which needs warming up.

If the printing processor 34 is not standing by, the controller 32 starts printing preparation so that the printing processor 34 is ready to print (step S110), waits until printing preparation is completed (step S120), and transmits “200 OK” (step S130), thereby stopping the response process. Herein, printing preparation includes warming up or the like by applying an electric current to the component, to which the electric current has not been applied in the power-saving mode. As such, since “200 OK” is transmitted after the completion of printing preparation, the transmitting terminal 20 is allowed to transmit printing contents data and the receiving terminal 30 is allowed to print the printing contents data right after the establishment of the connection. This, as a result, can reduce the time to be consumed from the establishment to the closing of the session, thereby reducing the amount of the fee in the case where time is charged.

In this exemplary embodiment as described above, when the INVITE message from the transmitting terminal 20 is received, the receiving terminal 30 promptly transmits “200 OK” if the printing processor 34 is in a standby state, in which it is ready to print. If the printing processor 34 is not standing by, the receiving terminal 30 starts printing preparation, waits until printing preparation is completed, and then transmits the “200 OK.” Accordingly, right after the session is established, the transmitting terminal 20 can transmit printing contents data and the receiving terminal 30 can print the printing contents data. As a result, it is possible to reduce the time to be used from the establishment to the closing of the session, thereby reducing the amount of the fee in the case where time is charged.

Herein, in this exemplary embodiment, the IP network 10 corresponds to a “communication network,” and the receiving terminal 30 having the printing processor 34 corresponds to a “printing terminal apparatus.” In addition, the controller 32, which performs the response process shown in FIG. 3 in response to the INVITE message from the transmitting terminal 20, corresponds to “a connection approval signal transmission processor.” Specifically, the controller 32 promptly transmits, if the printing processor 34 is standing by, “200 OK”, and performs, if the printing processor 34 is not standing by, printing preparation, waiting until printing preparation is completed, and then transmitting “200 OK.”

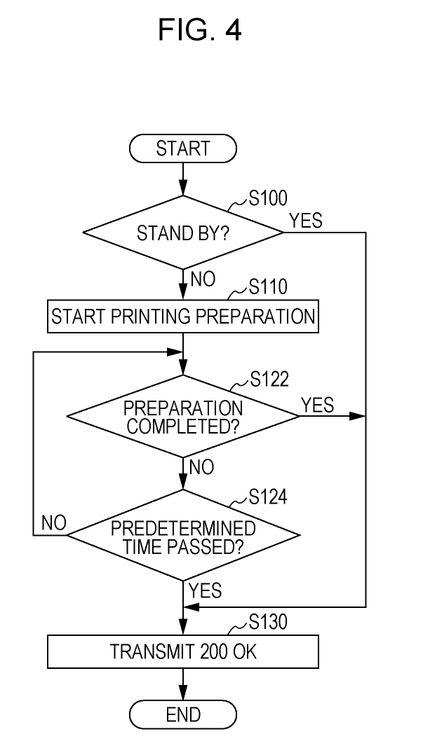

This exemplary embodiment has been described that, when the INVITE message from the call terminal 20 is received, the receiving terminal 30 starts printing preparation, waits unit printing preparation is completed, and then transmits “200 OK” if the printing processor 34 is not standing by. However, in the case of stopping the process rather than waiting for the establishment of the session, when “200 OK” is not received for a time-up period after the transmitting terminal transmitted the INVITE message, it is possible to set to transmit “200 OK” when a time period somewhat shorter than the time-up period passes even if printing preparation is being performed. In this case, a response process according to a modified embodiment shown in FIG. 4 is performed instead of the response process shown in FIG. 3. In the response process shown in FIG. 4, after printing preparation is started, the completion of printing preparation is delayed until a predetermined time passes after the INVITE message is received (step S122, S124). If the printing preparation is completed before the predetermined time is passed, “200 OK” is transmitted (step S130), thereby stopping the response process. If printing preparation is not completed before the predetermined time passes, the “200 OK” is transmitted even if printing preparation is being performed (step S130), thereby stopping the response process. This makes it possible to more reliably establish the session.

Although the receiving terminal 30 of this embodiment has been described that both the scanning processor 35 and the memory card driver 37 are mounted, only one or neither of the scanning processor 35 and the memory card driver 37 can be mounted.

While this exemplary embodiment has been described that the transmitting terminal 20 is provided with the printing processor 24, the scanning processor 25, and the memory card driver 27, the transmitting terminal 20 may have only some of the printing processor 24, the scanning processor 25, and the memory card driver 27 or may have none of them as long as it stores the printing contents data to be transmitted. In other words, the transmitting terminal 20 can have any configuration as long as it can transmit the printing contents data.

While the present invention has been described with reference to certain exemplary embodiments thereof, the present invention is not intended to be limited by the above illustrated embodiments. Rather, various changes in form can be made without departing from the scope of the present invention.

The present invention is applicable to the manufacturing industry of print apparatus terminals.

What is claimed is:

1. A printing apparatus terminal connected to a communication network and having a printer, which prints printing contents on a printing medium, wherein the printing apparatus terminal establishes a communication connection with a transmitting terminal through the communication network by transmitting a connection approval signal to the transmitting terminal through the communication network in response to a connection request signal, which is received through the communication network from the transmitting terminal, which is connected to the communication network to transmit the printing contents through the communication network, the printing apparatus terminal comprising:
a connection approval signal transmission processor, which, when the connection request signal is received, if printing preparation is completed so that the printer is ready to print, promptly transmits the connection approval signal to the transmitting terminal through the communication network, and if printing preparation is not completed, performs printing preparation and transmits the connection approval signal to the transmitting terminal through the communication network when printing preparation is completed.

2. The printing apparatus terminal according to claim 1, wherein, if printing preparation is not completed and when printing preparation is being performed, the connection approval signal transmission processor transmits the connection approval signal even if printing preparation is not completed if a predetermined time is passed after the connection request signal is received.

3. The printing apparatus terminal according to claim 1, wherein the communication network is a next generation network, and the communication connection is established based on session initiation protocol.

4. A method for controlling a printing apparatus terminal when transmitting a connection approval signal, wherein the printing apparatus terminal is connected to a communication network and has a printer, which prints printing contents on a printing medium, wherein the printing apparatus terminal establishes a communication connection with a transmitting terminal through the communication network by transmitting the connection approval signal to the transmitting signal through the communication network in response to a connection request signal, which is received through the communication network from the transmitting terminal, which is connected to the communication network to transmit the printing contents through the communication network, the method comprising:
when the connection request signal is received, if printing preparation is completed so that the printer is ready to print, promptly transmitting the connection approval signal to the transmitting terminal through the communication network, and if printing preparation is not completed, performing printing preparation and transmitting the connection approval signal to the transmitting terminal through the communication network when printing preparation is completed.
